(19) United States
(12) Patent Application Publication
(10) Pub. No.: US 2015/0253524 A1
(43) Pub. Date: Sep. 10, 2015

(54) OPTICAL CONNECTION DEVICE AND METHOD FOR MANUFACTURING THE SAME

(71) Applicant: KABUSHIKI KAISHA TOSHIBA, Tokyo (JP)

(72) Inventors: Masaki ITO, Onga Fukuoka (JP); Yuichi TAGAMI, Kitakyushu Fukuoka (JP); Kosei Fujioka, Kitakyushu Fukuoka (JP)

(21) Appl. No.: 14/634,862

(22) Filed: Mar. 1, 2015

(30) Foreign Application Priority Data
Mar. 4, 2014 (JP) 2014-041793
Sep. 5, 2014 (JP) 2014-181121

(51) Int. Cl. G02B 6/42

(52) U.S. Cl. CPC G02B 6/4278; G02B 6/4257; G02B 6/423

(57) ABSTRACT

An optical connection device includes an optical link module that includes an optical unit having an optical element and a lead connected to the optical element, and a first member in which the optical unit is mounted, and a second member that has an aperture in which the optical link module is fit. An outside surface of the first member includes a first protruding portion, and an inside surface of the second member includes a second protruding portion which intersects and is in contact with the first protruding portion.

### CROSS-REFERENCE TO RELATED APPLICATION

This application is based upon and claims the benefit of priority from Japanese Patent Application No. 2014-041793, filed Mar. 4, 2014 and Japanese Patent Application No. 2014-181121, filed Sep. 5, 2014, the entire contents of which are incorporated herein by reference.

### FIELD

Embodiments described herein relate generally to an optical connection device.

### BACKGROUND

An optical connection device includes an optical transmission module or an optical reception module. The optical transmission module and the optical reception module are coupled with an optical fiber using a connector or the like. For example, when a ferrule is provided at a tip end of the optical fiber and the optical transmission or reception module includes a receptacle, the optical fiber ferrule is fit into the receptacle. In this case, it is necessary that a central axis of the ferrule and a central axis of the receptacle are precisely aligned along a common axis. When a housing of the optical link module is a molded member, high precision molding may be required.

Optical link devices are widely used in the communication of control signals for machine tools, computer data links, and the like. In these applications, optical link devices are mounted by inserting pins extending therefrom into mounting substrates. The ferrule of the optical fiber to be coupled with the optical connection device on the mounting substrate is often not positioned at a specific angle, such as parallel or perpendicular to the mounting substrate, and hence the ferrule of the optical fiber must often be bent to insert the fiber into the optical connection device. This may result in residual force in the optical fiber, which may result in a loss of light transmission and signal quality.

### DESCRIPTION OF THE DRAWINGS

FIG. 1A is a schematic perspective view of an optical link device according to a first embodiment before connecting the components thereof. FIG. 1B is a schematic perspective view of the optical link device according to the first embodiment after connecting the components thereof.

FIG. 2A is a schematic perspective view of an optical unit receivable in the optical link device of FIGS. 1A and 1B. FIG. 2B is a schematic cross-sectional view of a first molded resin body in which the optical unit is received.

FIG. 3 is a schematic cross-sectional view of the optical link device according to a second embodiment.

FIG. 4A is a schematic perspective view of an optical link module of the optical link device according to a third embodiment. FIG. 4B is a schematic perspective view of an adapter of the optical link device according to the third embodiment. FIG. 4C is a schematic cross-sectional view of the optical link device.

FIG. 5A is a schematic perspective view of the adapter of the optical link device according to a fourth embodiment. FIG. 5B is a schematic plan view thereof. FIG. 5C is a schematic front view thereof. FIG. 5D is a schematic side view thereof.

FIG. 6A is a schematic perspective view in which an optical axis of the optical link device of the fourth embodiment is horizontal. FIG. 6B is a schematic perspective view in which the optical axis is vertical. FIG. 6C is a schematic perspective view in which the optical axis is set at 45 degrees.

FIG. 7A is a schematic perspective view illustrating an upper portion of a connection terminal. FIG. 7B is a schematic perspective view illustrating a tip end portion of a lead terminal of the optical link module. FIG. 7C is a schematic perspective view of the connection terminals.

FIG. 8A is a schematic perspective view of the optical link device according to a fifth embodiment. FIG. 8B is a schematic perspective view of the adaptor thereof.

FIG. 9 is a configuration view of an optical link.

FIG. 10 is a schematic cross-sectional view of an optical link module according to a first modification example.

FIG. 11A is a schematic plan view of a plate spring portion in a state where an optical fiber is fixed therein. FIG. 11B is a schematic perspective view of the plate spring portion in a state where the optical fiber is fixed therein. FIG. 11C is a schematic plan view of the plate spring portion in a state where the optical fiber is not fixed. FIG. 11D is a schematic perspective view of the plate spring portion in a state where the optical fiber is not fixed.

FIG. 12A is a schematic plan view of the optical link module in a state where the optical fiber is fixed. FIG. 12B is a schematic cross-sectional view of the optical link module taken along line A-A in FIG. 12A.

FIG. 13 is a schematic cross-sectional view of the optical link module according to a second modification example.

### DETAILED DESCRIPTION

One or more embodiments are directed to provide an optical connection device which may change a direction of an optical axis, with respect to a mounting substrate.

In general, according to one embodiment, an optical connection device includes an optical link module that includes an optical unit having an optical element and a lead connected to the optical element, and a first member in which the optical unit is mounted, and a second member that has an aperture in which the optical link module is fit. An outside surface of the first member includes a first protruding portion, and an inside surface of the second member includes a second protruding portion which intersects and is in contact with the first protruding portion.

Hereinafter, embodiments will be described with reference of drawings.

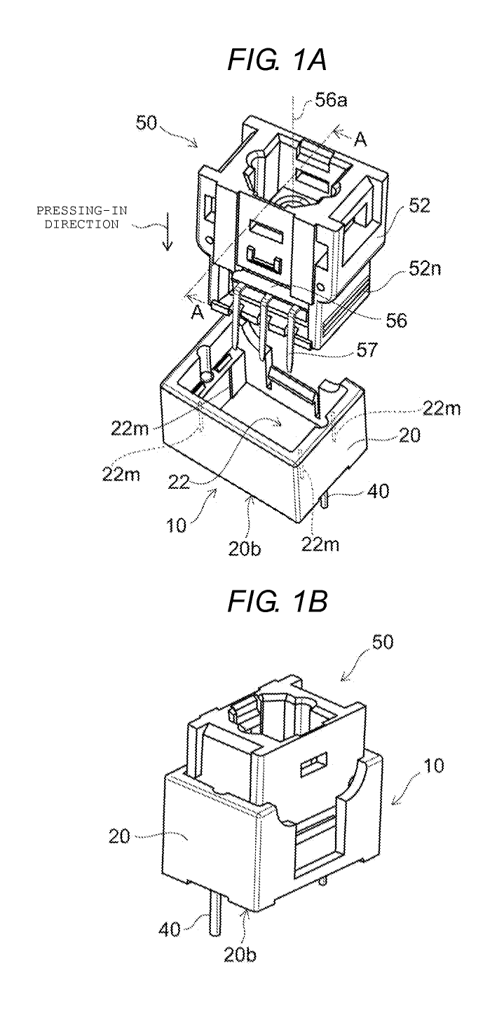

FIG. 1A is a schematic perspective view of an optical link device according to a first embodiment before connecting the components thereof. FIG. 1B is a schematic perspective view of the optical link device according to the first embodiment after connecting the components thereof.

The optical link device according to the first embodiment includes an optical link module 50 and an adapter 10.

The optical link module 50 has an optical unit 56 and a first molded resin body 52 in which the optical unit 56 is received. The optical unit 56 has a plurality of leads 57, an optical element which has an optical axis 56a connected to the leads 57, and a transparent resin layer (not illustrated). The optical link module 50 may be, for example, an optical transmitter, an optical receiver, or the like.

The adaptor 10 has a second molded resin body 20 in a frame shape in which a through-hole 22 into which the optical link module 50 is inserted is provided, and a mounting pin 40 having an end portion secured within the second molded resin body 20 and the other end portion protruding from a bottom surface 20b of the second molded resin body 20 to be received in a mounting substrate (not shown).

As the composition material of the first molded resin body 52 and the second molded resin body 20, for example, a Polybutylene Terephthalate (PBT) resin or a Polycarbonate (PC) resin may be used. The PBT resin and the PC resin are thermoplastic resins. When the PBT resin and the PC resin are heated to equal to or higher than a glass transition point temperature thereof, the PBT resin and the PC resin become soft and able to be molded to a desired shape. In addition, when a conductive resin is used, it is possible to improve a shield effect of the molded resin bodies.

As illustrated in FIG. 1A, for example, on one inside surface of the second molded resin body 20, second protruding portions 22m (two second protruding portions 22m extending in a vertical direction generally parallel to, and spaced from, the optical axis 56a in the drawing) which extend in the insertion direction of the first molded resin body 52 into the second molded resin body 20, are provided. In addition, similarly, on the other inside surface of the second molded resin body facing the one inside surface, two second protruding portions 22m which extend in the insertion direction are provided. On one outside surface of the first molded resin body 52, first protruding portions 52n (three first protruding portions 52n extending in a horizontal direction, generally perpendicular to the optical axis 56a in the drawing) which extend perpendicular to the second protruding portions and to the insertion direction of the first molded resin body 52 into the second molded resin body 20 are provided. In addition, similarly, on the other outside surface on the opposite side of the first molded resin body 52, first protruding portions 52n extend perpendicular to the second protruding portions and to the insertion direction of the first molded resin body 52 into the second resin molded body 20 are provided (not illustrated). In addition, the number of the first protruding portions 52n and the number of the second protruding portions 22m are not limited to the number thereof shown in the Figures.

Therefore, where the optical link module 50 is fitted into the adapter 20, an extending direction of the first protruding portion 52n and an extending direction of the second protruding portion 22m intersect with each other, and the first protruding portion 52n and the second protruding portion 22m are in contact with each other, firmly fixing the optical link module 50 and the adapter 20 together. Accordingly, since the optical link module 50 and the adapter 20 are firmly fixed to each other, rattling or movement between them is not generated, and therefore, an optical axis 56a of the optical link module 50 may be fixed in one direction without being shifted with respect to the adapter 20, and the desired alignment of a fiber cable mounted therein to the optical axis of the optical unit 56 may be maintained. When the bottom surface 20b of an adapter 10 formed of the second molded body 20 is disposed to be parallel to a surface of the mounting substrate, the optical axis 56a is orthogonal to the mounting substrate.

In this manner, the first protruding portion 52n is provided on a side surface of the optical link module 50 which is used in a horizontal type connection in the first embodiment. By mounting the provided first protruding portion 52n to the adapter 20, an optical link device wherein the optical fiber extends vertically with respect to a horizontal mounting substrate may be provided. Because the optical unit is received in the adaptor with the terminals 57 thereof bent at 90 degrees to the optical axis 56a, by attaching and detaching the first molded resin body 52 into and out of the adapter, it is possible to change the direction of the optical axis to the horizontal direction with respect to a substrate as compared to the situation where the terminals 57 are not bent and the optical unit 56 extends upwardly from a mounting substrate and the optical axis is generally parallel to the mounting substrate surface, i.e., the vertical direction. Because protruding portions 52n on an inside surface of the adapter and a protruding portion on an outside surface of the optical link module 50 are in interference contact with each other, the adapter and the optical link module are firmly fixed to each other. For this reason, deviation of the optical axis from the end of the optical fiber is not generated by misalignment or loosening of the optical link module in the adaptor. However, the embodiment is not limited thereto, and the optical axis 56a and the mounting substrate may intersect diagonally.

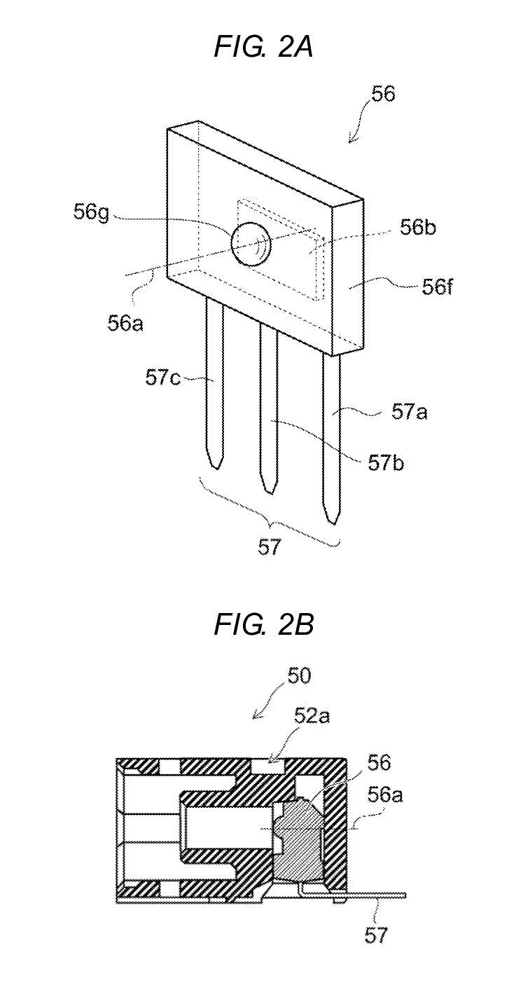

FIG. 2A is a schematic perspective view of an optical unit. FIG. 2B is a schematic cross-sectional view of a first molded resin body in which the optical unit is interposed and the leads thereof are bent.

In addition, FIG. 2B is a schematic cross-sectional view taken along the line A-A in FIG. 1A. On a surface of a transparent resin layer 56f on the upper portion of an optical element 56b, a convex lens 56g or the like may be provided. The optical unit 56 is located, such as by being press fit, inside the first molded resin body 52. The lead 57 may include an output signal terminal 57a, a power supply terminal 57b, a grounding terminal 57c, or the like for connection of the optical element 56b to an external power source and a control terminal. In FIG. 2B, the leads 57 are bent to extend generally parallel to the optical axis 56a, and thus generally perpendicular to the surface at which the lens 56g is located.

In a case where the optical element is an optical transmitter, the optical element 56b may be a light-emitting element, such as an LED, an LD, or a Vertical Cavity Surface Emitting Laser (VCSEL). In addition, in a case where the optical element is an optical receiver, the optical element may be a light-receiving element, such as a photodiode, or a light-receiving IC.

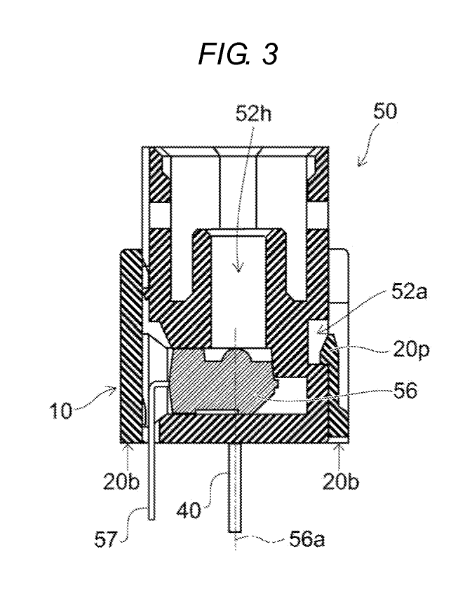

FIG. 3 is a schematic cross-sectional view of an optical link device according to a second embodiment.

In the embodiment, the optical link module 50 is a receptacle type. In other words, the optical link module 50 has a ferrule guide portion 52h which guides a ferrule on the tip end portion of an optical fiber into alignment with the optical axis, such that the optical fiber is optically coupled with the optical element 56b, and is also physically secured within the optical link module 50.

In addition to, or as an alternative to, providing a protrusion structure as the first protruding portion 52n and the second protruding portion 22m as shown in FIG. 1A, as illustrated FIG. 3 a claw-shaped protruding portion 20p may be provided on an inside surface of the through-hole 22 of the adapter 10, and a recessed portion 52a forming a claw receiving ledge is provided on the outside surface of the first molded resin body 52 of the optical link module 50. Where the claw-shaped protruding portion 20p is extended into the recessed portion 52a of the first molded resin body 52, the optical link module 50 becomes releasably locked into the adapter 10. In addition, one end portion of the leads 57 of the optical unit 56 contact the side of the bottom surface 20b of the second molded resin body 20 of the adapter, for example, to connect with a wiring portion on a mounting substrate (not shown) which is configured to be substantially parallel to the optical axis 56a.

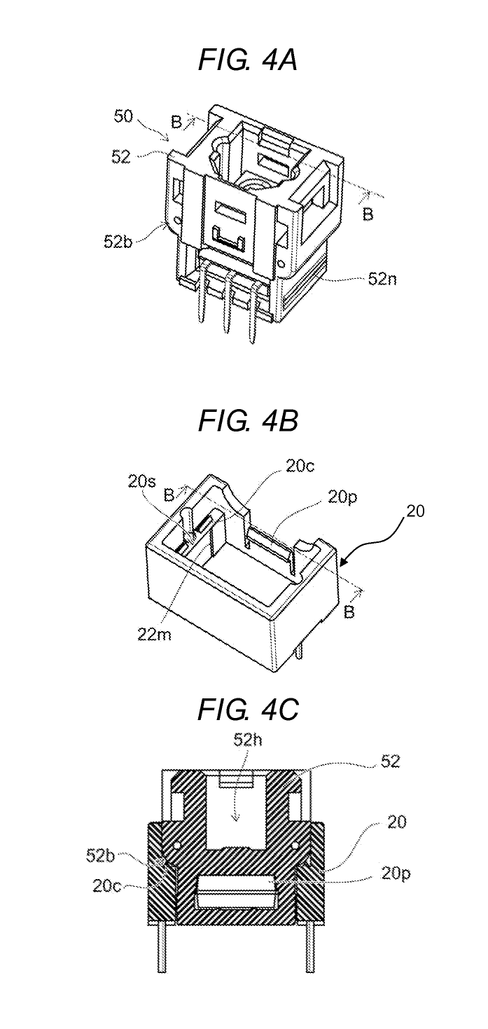

FIG. 4A is a schematic perspective view of an optical link module of an optical link device according to a third embodiment. FIG. 4B is a schematic perspective view of the adapter of the optical link device according to the third embodiment. FIG. 4C is a schematic cross-sectional view of the optical link device.

The adapter 10 of the optical link device of the third embodiment has a protruding portion 20c provided on a step portion 20s of the inside surface thereof, and the optical link module 50 includes a protruding curved surface 52b provided on the outside surfaces of the optical link module 50.

A protruding portion 20c abuts against the protruding curved surface 52b and a deformation of the protruding portion 20c is generated such as a crushed end at the tip end of the protruding portion 20c thereof. The optical link module 50 extends upwardly therefrom. The claw-shaped protruding portion 20p is securely locked to the recessed portion 52a.

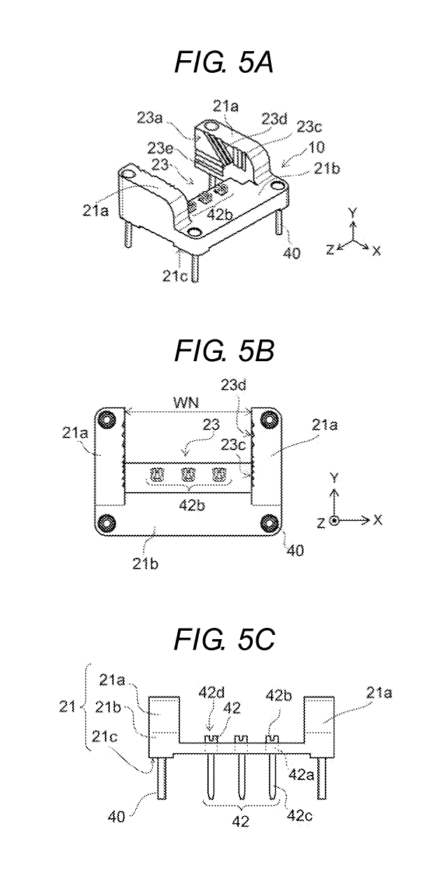

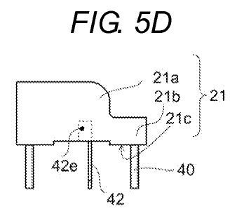

FIG. 5A is a schematic perspective view of the adapter of the optical link device according to a fourth embodiment. FIG. 5B is a schematic plan view thereof. FIG. 5C is a schematic front view thereof. FIG. 5D is a schematic side view thereof.

The adapter 10 of the optical link device of the fourth embodiment has a second molded resin body 21 and a mounting pin 40.

The second molded resin body 21 of the embodiment has a pair of opposed side portions 21a provided to receive and secure the optical link module 50 therebetween, and a bottom portion 21b extending between the opposed side portions 21a. Each of the side portions 21a has a portion in which the bottom portion 21b does not extend therebetween, i.e. a gap is formed therebetween adjacent one side of the bottom portion 21b. In addition, at least a portion of the bottom portion 21b has a portion at which the pair of side portions 21a does not extend, i.e., at a location opposite to the gap, the bottom portion 21b extends beyond the ends of the opposed side portions 21a. As illustrated in FIGS. 5B and 5C, when viewed in a plan view or in a front view, the shape of the second molded resin body is substantially a U-shape. The cutout portion 23 about which the U-shaped profile of the second molded resin body 21 is formed is provided between the opposed side portions 21a. The optical link module 50 is inserted into the cutout portion 23 of the second molded resin body 21 to secure the optical link module 50 thereto.

The mounting pins 40 have one end portion and another opposed end portion. For example, one end portion is fitted into the second molded resin body 21. The other end portion of the mounting pin 40 is inserted into a mounting substrate (not shown) or the like. The adapter 10 formed by the second molded resin body 21 and provided with the cutout portion 23 is attached to amounting substrate (not shown) by the mounting pins 40.

In addition, the adapter 10 may further include connection terminals 42. Of the connection terminals 42 secured therein, a central portion 42a of these connection terminals 42 is secured into the second molded resin body 21, a first end portion 42c of these connection terminals 42 extend from a bottom surface 21c of the adaptor 10, and a second end portion 42b of these connection terminals 42 protrudes from a side opposite to the first end portion 42c, i.e., into the U-shaped recess forming cutout portion 42c. On an inside surface 23a of the cutout portion 23, i.e., the inner walls of the opposed sides 21a of the second molded resin body 21, inwardly extending recessed portions 23c, 23d, and 23e comprising pluralities of generally parallel grooves having a triangular depth profile are provided, each set of recessed portions 23c, 23d and 23e extending at a different angle with respect to the bottom surface 21c of the adaptor 10. By providing protrusions on the optical link module 50 formed of the first molded resin body 52 which have a mating profile, parallelism and size with respect to the recessed portions 23, the molded resin body 52 may be secured into the adaptor 10 formed of the second resin molded body 20 at discrete angles to the bottom portion 21b based upon which of the sets of recesses 23c, 23d, or 23e the protrusions are extended into. In addition, at the second end portion 42b of the connection terminals 42, a tip end groove portion 42d is provided.

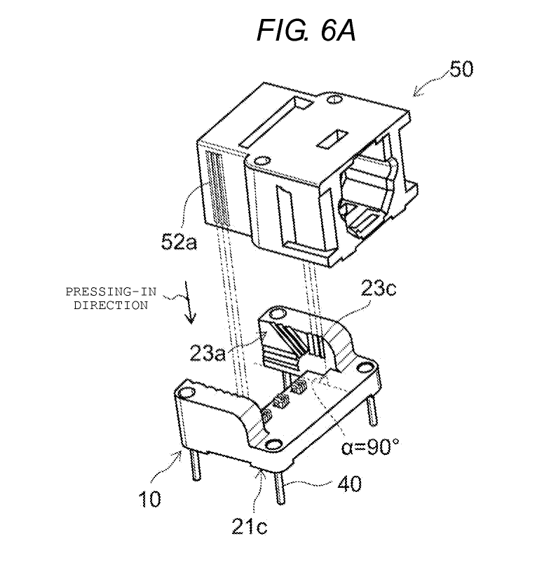

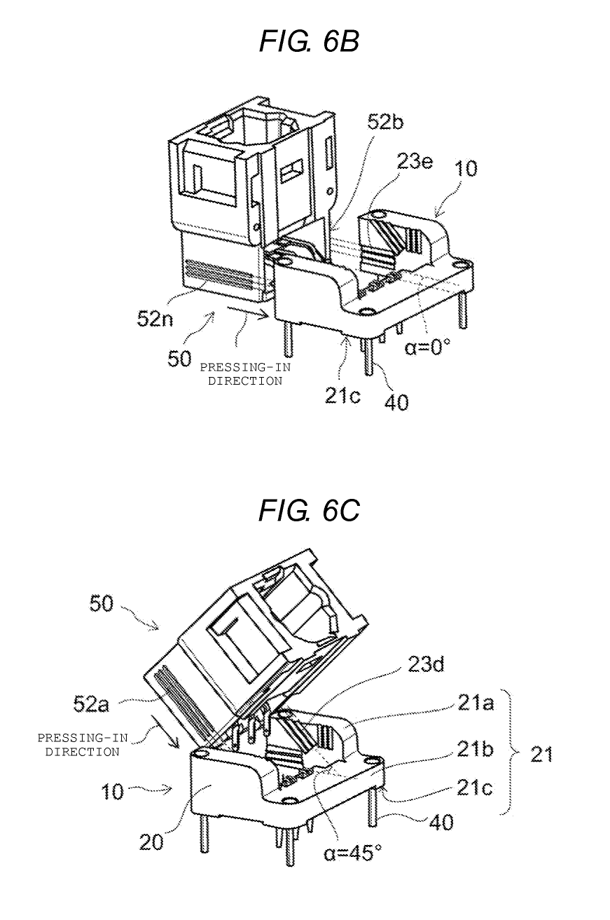

FIG. 6A is a schematic perspective view in which the optical axis of the optical link module 50 of the fourth embodiment is configured to be positioned horizontally, i.e., inserted in a direction generally parallel to the bottom portion 21b of the adaptor 10 described with respect to FIGS. 5A to 5D. FIG. 6B is a schematic perspective view in which the optical axis of the optical link module 50 is configured to be positioned in the adaptor 10 vertically, i.e., inserted in a direction generally perpendicular to the bottom portion 21b of the adaptor 10. FIG. 6C is a schematic perspective view in which the optical axis of the optical link module 50 is inserted in a direction generally at 45 degrees with respect to the bottom 21B of the U-shaped recess of the adaptor 10.

In FIG. 6A, protruding portions 52a provided on the side surface of the first molded resin body 52 of the optical link module 50 are shown being inserted in a vertical direction (angle α with respect to the bottom surface 21c=90 degrees) so as to engage into the mating profile of the grooves of the recessed portion 23c of the inside surface 23a of sides of the cutout portion 23. As a result, the protruding portions 52a and the recessed portions 23c of the adaptor 10 fit together with the peaks of one received in the valleys of the other, and vice versa, and the optical axis 56a of the optical link module 50 extends in a horizontal alignment with respect to amounting substrate (not shown) having a horizontal mounting surface.

In FIG. 6B, protruding portions 52a provided on the side surface of the first molded resin body 52 of the optical link module 50 are shown being inserted in a horizontal direction (angle α with respect to the bottom surface 21c=0 degrees) so as to engage into the mating profile of the grooves of the recessed portion 23c of the inside surface 23a of the sides of the cutout portion 23. As a result, the protruding portions 52a and the recessed portions 23c of the adaptor 10 fit together with the peaks of one received in the valleys of the other, and vice versa, and the optical axis 56a of the optical link module 50 extends in a vertical alignment with respect to a mounting substrate (not shown) having a horizontal mounting surface.

In FIG. 6C, protruding portions 52a provided on the side surface of the first molded resin body 52 of the optical link module 50 are shown being inserted into the recessed portions 23d of the inside surface 23a of the cutout portion 23 extending in a direction of 45 degrees (angle α=45 degrees with respect to bottom surface of the adaptor and thus the surface of a mounting substrate (not shown)) to secure the first molded resin body 52 of the optical link module 50 to the second molded resin body 20 comprising the adaptor 10. In this Figure, the first molded resin body 52 is slid into the adaptor at a 45 degree angle to the previously described interconnection paradigms. As a result, the protruding portions 52a and the recessed portion 23d of the adaptor 10 fit together with the peaks of one received in the valleys of the other, and vice versa, and the optical axis 56a of the optical link module 50 is at 45 degrees from the bottom surface 21a of the adaptor and an underlying mounting substrate. In addition, the adapter 10 may have the protruding portions and the optical link module 50 may have the recessed portions.

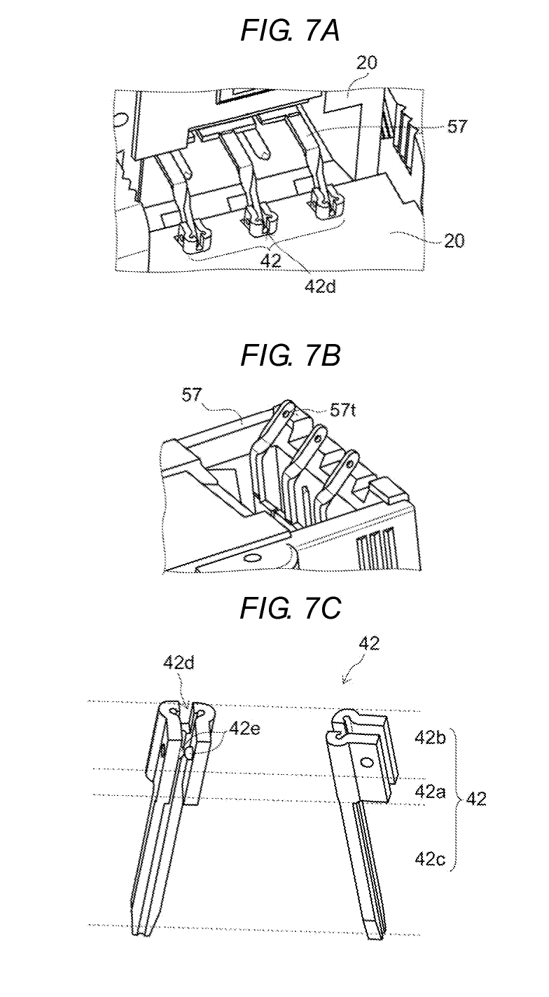

When the bottom surface 21c of the adapter 10 is disposed to be parallel to the surface of the mounting substrate, using the same adaptor 10 of FIGS. 5A to 5D and the same first molded resin body 52 of FIGS. 6A to 6C, the angle at which the mounting substrate and the optical axis 56a of the first molded resin body 52 intersect may be changed, in the specific example herein, at 0 degrees, 45 degrees, or 90 degrees with respect to a mounting substrate. In addition, since the lead 57 of the optical unit 56 is inserted into the connection terminal 42, it is unnecessary to connect the terminals 57 of the optical unit 56 to the wiring portion of a mounting substrate by soldering or the like, as will be described herein with respect to FIGS. 7A to 7C.

FIG. 7A is a schematic perspective view illustrating an upper portion of the connection terminals 42 protruding into the recess area of the second molded resin body forming the adaptor. FIG. 7B is a schematic perspective view illustrating a tip end portion of a lead terminal of the optical link module. FIG. 7C is a schematic perspective view of the connection terminal.

As illustrated in FIG. 7A, a tip end groove portion 42d is provided in the protruding end of the connection terminals 42, and the lead 57 of the optical link module 50 is received in the tip end groove portion 42d of the connection terminals 42. In addition, a through-hole 57t as shown in FIG. 7B extends through the tip end portions of the leads 57 extending from the first molded body 52, and protruding portions 42e are provided on both side surfaces of the tip end groove portion 42d of the connection terminals and facing inwardly of the groove portions 42d from either side thereof. Thus when the tip ends of the leads 57 are positioned within the tip end groove portions 42d of the connection terminals 42, the protruding portions 42e thereof extend into the through holes 57t, to secure the leads 57 in the connection terminals 42, in each of the horizontal, vertical and 45 degree angle configurations.

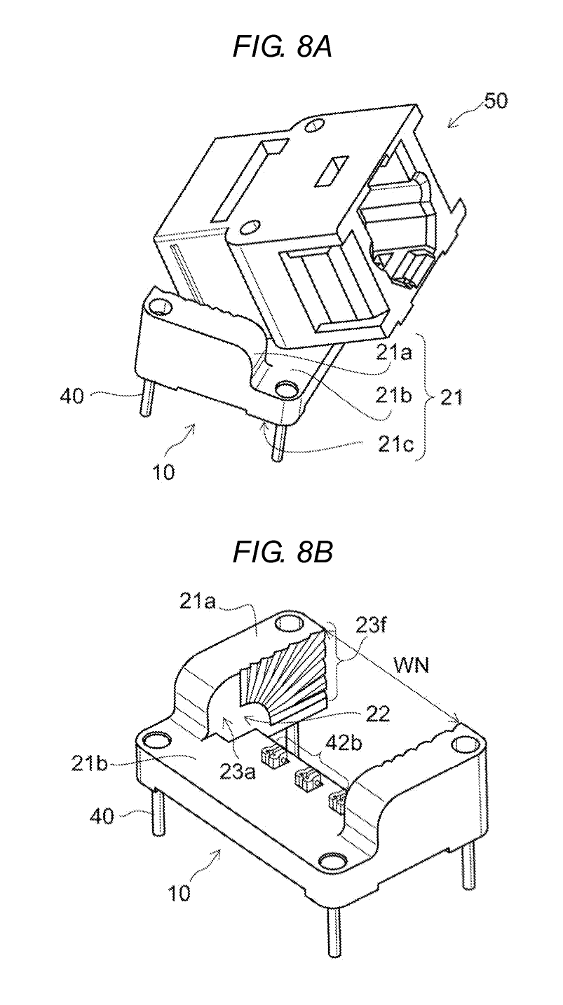

FIG. 8A is a schematic perspective view of the optical link device according to a fifth embodiment. FIG. 8B is a schematic perspective view of the adaptor thereof.

As illustrated in FIG. 8B, on the inside surface 23a of the cutout portion 23, recessed portions 23f may be provided in a radial shape aligned with an imaginary line passing through the protruding portions 42e of the connection terminal 42 as the center point of a plurality of lines along which the recessed portions 23f extend. As the recessed portion 23f having a slant of equal to or higher than 0 degrees from bottom portion 21b and equal to or less than 90 degrees from bottom portion 21b are provided, it is possible to adjust the position of the first molded resin body 52 in the second molded resin body 20 to different angles with respect to the surface of a mounting substrate.

In this embodiment, as few as a single first protruding portion 52n may be provided on opposed sides of the first molded resin body 52. The recessed portions 23c, 23d, and 23e of the second molded resin body 20 may include a plurality of individual recesses, each recess aligned at a different angle to bottom portion 21a of the second molded resin body, or groups of recesses, wherein the recesses of each group are parallel to one another and the angle of the recesses of each group is different from the angle of the recesses of another group of recesses. In addition, a width WN of the cutout portion 23 is widened. The optical link module 50 having a single protruding portion 42e along either side thereof is positioned in the adaptor 10 by sliding the projection thereof into one of the recesses 23f, and once in place the position thereof with respect to the bottom 21a of the adaptor 10 may be adjusted by twisting or turning the optical link module in the adaptor to move the projecting portion on either side thereof into a different one of recesses of the recessed portion 23f. additionally, as the holes 57t in the terminals receive the projections 42e in the connection terminal, and the recesses of the recessed portion all intersect an imaginary line extending through openings 57t, the terminals 57 will stay within the openings of the connection terminals as the optical link module is positioned in different ones of the recesses in the recessed portion 23f.

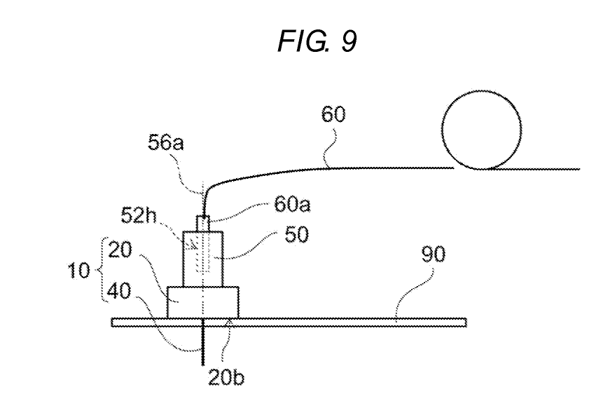

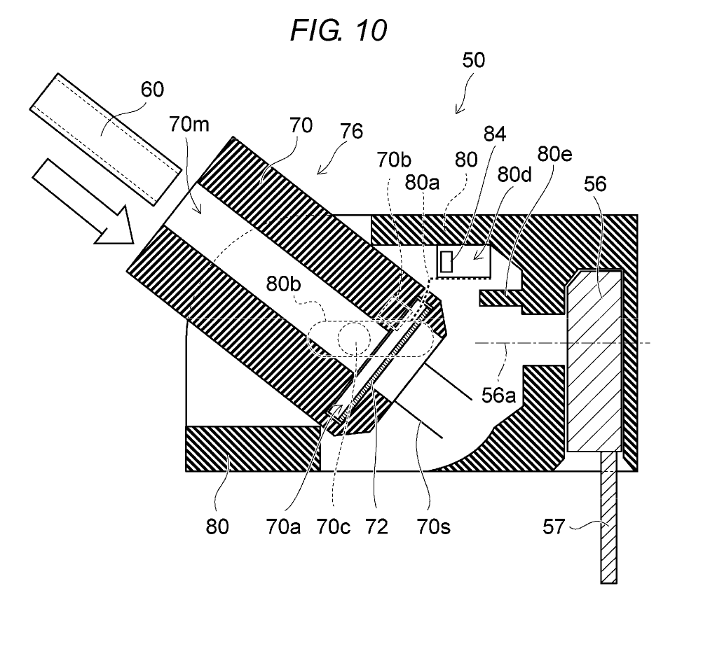

FIG. 9 is a configuration view of an optical link. The other end portion of the mounting pins 40 extend through a mounting substrate 90. In addition, on the mounting substrate 90, it is possible to have a power supply portion such as conductive lines or the like which connect to the terminals 57 to power or receive signals from the optical unit 56, or the like.

With respect to the surface of the mounting substrate 90, it is possible to adjust the angle of the optical axis 56a of the optical link module 50 to equal to or higher than 0 degrees and equal to or less than 90 degrees.

According to a transmission distance or a modulation rate that are required in an optical system, a quality of a material of an optical fiber 60 is selected from quartz, plastic or the like. When the transmission distance is a short distance of equal to or less than 1,000 m, it is possible to use a Plastic Optical Fiber (POF), or Plastic Clad Silica Fiber (PCF). In addition, in a case of the short distance transmission, the light-emitting element is made of InAlGaP, AlGaAs, or the like, and an emission wavelength thereof may be in a range of 500 to 900 nm.

In a case of the receptacle type, in order to insert the ferrule 60a into a ferrule guide portion 54a, high dimensional precision is required with respect to a molded article. For this reason, a highly precise molding which has at least three or more releasing directions is necessary. With respect to the mounting substrate 90, if a dedicated mold is prepared in which the central axis of the ferrule guide portion 52h of the first molded resin body 52 corresponds to one of a horizontal direction, an orthogonal direction, a slant direction, or the like, the cost will be higher because several different molds will be required for each configuration of horizontal, vertical, and angles therebetween of the optical axis 56a to the mounting substrate 90. According to the embodiment, when the highly precise molding which is necessary in the optical link module is commonly used, it is possible to reduce the cost of the optical link device by enabling varying of the optical axis 56a to the mounting substrate in a single two piece structure.

Since the optical link module 50 and the adapter 10 are not fitted to each other for purposes of optical coupling, high precision is unnecessary in the molding of the molded resin bodies, and thus it is possible to reduce the cost. In addition, the optical link module 50 may not be in a receptacle type, and may be in a plug type.

FIG. 10 is a schematic cross-sectional view of an optical link module according to a first modification example.

The optical link module 50 according to the first modification example is a connector-less module having a simple lock function. This drawing illustrates a state before the optical fiber 60 is fixed. The optical link module 50 further includes an optical fiber guide member 76 including a plate spring member 72 having an opening portion in an inner region, into which the optical fiber 60 may be inserted, a supporting body portion 70 having a recessed portion 70a that accommodates the plate spring member 72, a through hole 70m that may support the optical fiber 60, and a sleeve portion 70s which opposes the optical unit 56.

The supporting body portion 70 may be made of a resin, ceramic, metal, or the like. The supporting body portion 70 may have a cylindrical shape. In addition, when the sleeve portion 70s is made of metal, it is easy to align a central axis of the optical fiber 60 with the optical axis 56a of the optical unit 56.

In addition, on an inner surface of a first molded resin body 80, a guide groove portion 80b, a lock recessed portion 80d, and a plate spring pressurizing portion 80e, are provided. At an outer edge of the supporting body portion 70 of the optical fiber guide member 76, a guide protruding portion 70c, which may move along the guide groove portion 80b, and a lock protruding portion 70b may be provided.

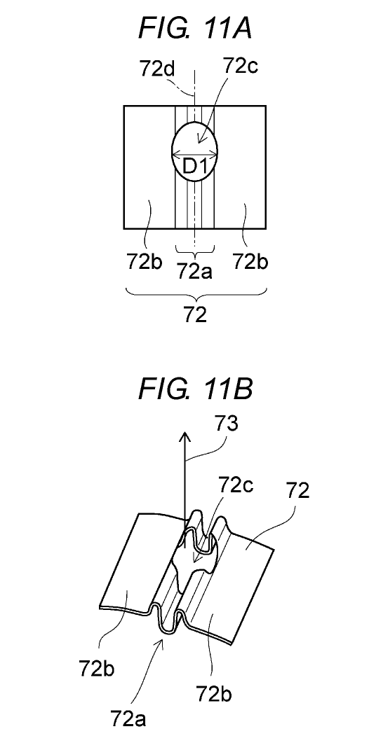

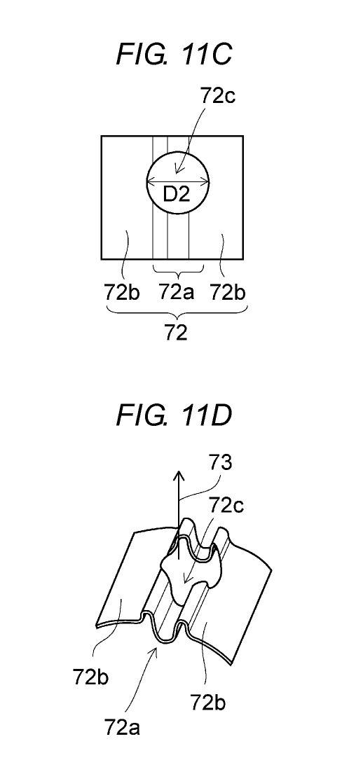

FIG. 11A is a schematic plan view of the plate spring member 72 in a state where an optical fiber is fixed. FIG. 11B is a schematic perspective view of the plate spring member 72 in a state where an optical fiber is fixed. FIG. 11C is a schematic plan view of the plate spring member 72 in a state where the optical fiber is not fixed. FIG. 11D is a schematic perspective view of the plate spring member 72 in a state where the optical fiber is not fixed.

The plate spring member 72 further includes outer portions 72b provided on outer sides of an inner portion 72a. The inner portion 72a may expand and contract along a direction which intersects an inserting direction 73 of the optical fiber 60. In addition, the outer portions 72b may expand and contract along the inserting direction 73. In other words, when the plate spring member 72 is pressurized in a direction of a front surface of the outer portion 72b of the plate spring member 72, a bending structure part of the inner portion 72a serves as another plate spring and contracts. In FIGS. 11C and 11D, three bending processes are performed in the plate spring portion 72. Here, the plate spring member 72 is made to be symmetrical with respect to a central axis 72d, but the exemplary embodiment is not limited to this shape.

The diameter D2 before compression of an opening portion 72c of the plate spring member 72 is sufficient for the optical fiber 60 to pass through. When a diameter including a covering portion of the optical fiber 60 is 2 mm, the diameter D2 before compression of the opening portion 72c of the plate spring member 72 may be, for example, 2.1 mm.

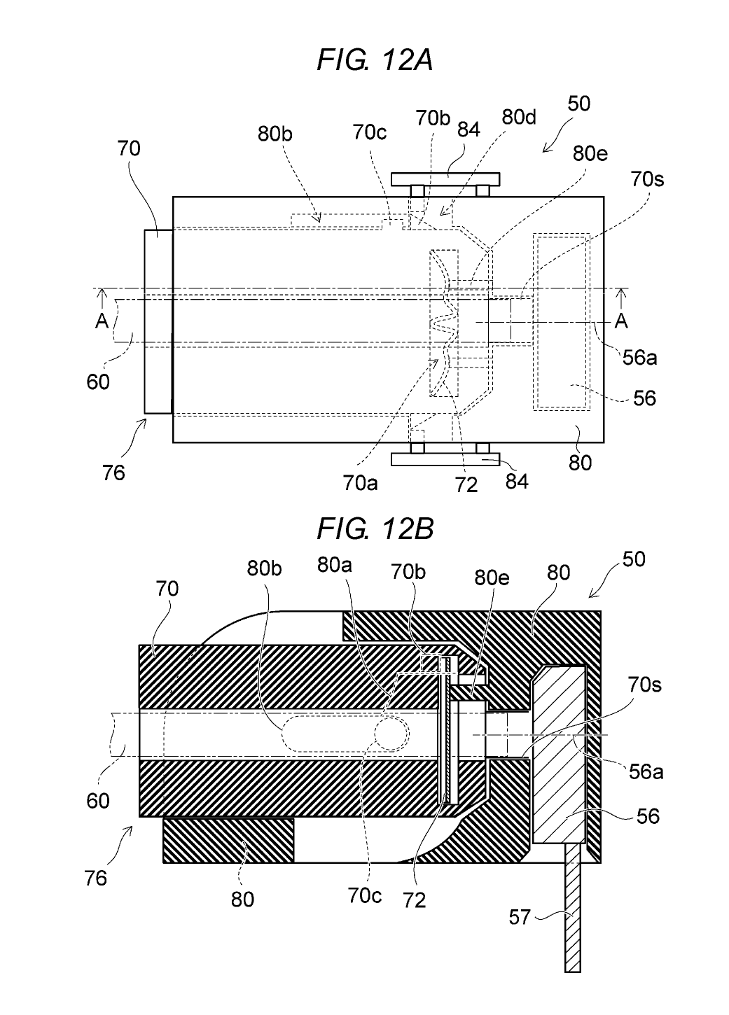

FIG. 12A is a schematic plan view of the optical link module in a state where the optical fiber is fixed. FIG. 12B is a schematic cross-sectional view along line A-A in FIG. 12A.

When the optical fiber guide member 76 moves along the guide groove portion 80b, and the lock protruding portion 70b and the lock recessed portion 80d are fitted to each other, the plate spring pressurizing portion 80e pressurizes the front surface of the outer portion 72b of the plate spring member 72, a width of the inner portion 72a is decreased (an inner diameter is D1), and a side surface of the optical fiber 60 is compressed. The lock protruding portion 70b has elasticity.

In addition, the optical link module may further include a lock releasing lever 84 which reaches the inside of the lock recessed portion 80d from an outer surface of the first molded resin body 80. By pulling out the optical fiber guide member 76 while the lock releasing lever 84 abuts against the lock protruding portion 70b and is pushed towards the lock protruding portion 70b, a pressurization state of the outer portion 72b of the plate spring member 72 is released, the width of the inner portion 72a is restored to the original width, and it is possible to detach the optical fiber 60.

In addition, on the inner surface of the first molded resin body 80, a lock protruding portion guide groove portion 80a having a curved line portion may be further provided. By guiding the lock protruding portion 70b along the curved line portion, it is possible to rotate and move the optical fiber guide member 76. Although the optical link module according to the first modification example has a simple structure, it is possible to maintain high optical coupling efficiency. In addition, the first modification example can be applied not only to a one-way optical module, but also to a two-way optical module. The lock protruding portion guide groove portion 80a may be a step or a protruding side surface which is provided on the inner surface of the first molded resin body 80.

In general, when a connector is attached to the optical fiber, it is necessary to polish an end surface, attach a cylindrical ferrule, and attach a connector lock mechanism and the like. For this reason, it is necessary to use high level of processing technology or dedicated tools, and to take times for processing. In addition, it is necessary to perform optical axis adjustment between the ferrule and the optical fiber.

In contrast, according to the first modification example, as the optical axis can be aligned easily by inserting the optical fiber 60 into the sleeve portion 70s, attachment to and detachment from the optical link module 50 may be easily performed using the plate spring member 72. In other words, a connector processing apparatus or the dedicated tools are not necessary, and it may take less time for connector processing or optical axis matching. For this reason, productivity can be improved, and the cost can be reduced.

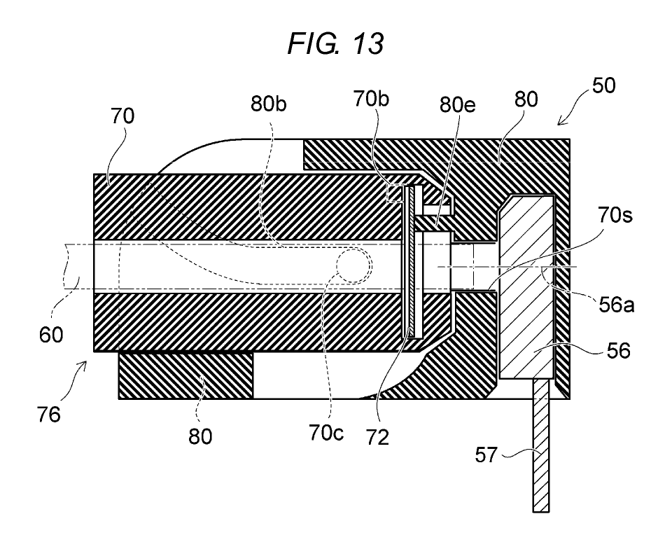

FIG. 13 is a schematic cross-sectional view of an optical link module according to a second modification example.

The optical link module 50 according to the second modification example is a connector-less module having a simple lock function. The guide groove portion 80b which is provided on the inner surface of the first molded resin body 80 has a curved line portion, and one end thereof is open. The guide protruding portion 70c which is provided in the supporting body 70 may move along the curved line portion. For this reason, it is possible to insert the optical fiber 60 at an arbitrary angle. In this case, as the lock protruding portion 70b is provided in the supporting body 70, it is not necessary to guide the supporting body 70.

According to the optical link device according to the first to fifth embodiments, it is possible to adjust the direction of the optical axis 56a with respect to the bottom surfaces 20b and 21c of the adapter 10 and thus to the mounting substrate. For this reason, it is possible to realize the optical link device having the optical axis 56a which has an angle of equal to or higher than 0 degrees and equal to or less than 90 degrees, with respect to the mounting substrate.

The optical link device may be widely used in a data link, a machine tool control, a process control, a PC network, or the like. In these applications, plural optical link devices are connected to each other by using plural optical fibers. According to the optical link module of the embodiment, the optical fibers may be laid in various directions with respect to the mounting substrate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An optical connection device, comprising:
an optical link module that includes an optical unit having an optical element and a lead connected to the optical element, and a first member in which the optical unit is mounted; and
a second member that has an aperture in which the optical link module is fit, wherein
an outside surface of the first member includes a first protruding portion, and
an inside surface of the second member includes a second protruding portion which intersects and is in contact with the first protruding portion.

2. The device according to claim 1, wherein
at least one of the first and second protruding portions includes a plurality of protrusions.

3. The device according to claim 1, wherein
the first protruding portion extends parallel to an optical axis of the optical link module, and
the second protruding portion extends orthogonal to the optical axis of the optical link module.

4. The device according to claim 1, wherein
the optical axis is orthogonal to a bottom surface of the second member from which the lead extends out of the second member.

5. An optical connection device, comprising:
an optical link module that includes an optical unit having an optical element a lead connected to the optical element, and a first member in which the optical unit is mounted; and
an adapter that includes a second member having a bottom portion and a pair of side portions positioned to receive the optical link module therebetween,
wherein, of an inside surface of the side portion of the second member and an outside surface of the first member that is positioned to face the inside surface, one surface has a protruding portion, and the other surface has a recessed portion positioned to fit the protruding portion.

6. The device according to claim 5, wherein the recessed portion has a triangular cross-sectional shape.

7. The device according to claim 5, wherein
the adapter further includes a connection terminal having a central portion fit into the bottom portion of the second member, a first end portion protruding from a bottom surface of the bottom portion, and a second end portion protruding towards a side opposite to the first end portion and having a groove, and
an end portion of the lead of the optical unit is positioned to fit the groove.

8. The device according to claim 5, wherein
the protruding or recessed portion of the second member extends in a straight line path, and an angle between the straight line path with respect to the bottom surface of the bottom portion is equal to or greater than 0 degrees and equal to or smaller than 90 degrees.

9. The device according to claim 8, wherein
the protruding or recessed portion of the second member includes a plurality of protruding or recessed regions extending in different directions with respect to the bottom surface of the bottom portion, and
the protruding or recessed portion of the first member is fittable to each of the plurality of regions.

10. The device according to claim 9, wherein
each of the plurality of protruding or recessed regions includes a single projection or recess, and paths of the projections or recesses extend from a single location.

11. The device according to claim 9, wherein
each of the plurality of protruding or recessed regions includes at least two projections or recesses, and paths of the projections or recesses in each region are parallel to one another, and angularly offset from paths of the projections or recesses in any other region.

12. The device according to claim 11, wherein
the plurality of protruding or recessed regions include at least a first region extending orthogonally to the bottom surface of the bottom portion, a second region extending parallel to the bottom surface of the bottom portion, and a third region extending at an angle between orthogonal and parallel to the bottom surface of the bottom portion.

13. The device according to claim 5, wherein
the optical link module includes a receptacle therein for receipt of an end of a fiber cable that is to be optically coupled with the optical unit.

14. The device according to claim 13, wherein the receptacle is detachable from the first member.

15. The device according to claim 14, wherein
one of the receptacle and the first member includes a recessed portion and the other of the receptacle and the first member includes a protruding portion positioned to fit the recessed portion.

16. A method for manufacturing an optical connection device, comprising:
forming a first member having side surfaces opposite to each other, each including a coupling surface;
forming a second member having a bottom portion and a pair of side portions that are opposite to each other and extend from the bottom portion, each of the side portions including a coupling surface that fits the coupling surface of the first member;
attaching the second member to a mounting substrate;
attaching an optical unit in the first member; and
coupling the first member with the second member, such that the coupling surface of the first member fits the coupling surface of the second member.

17. The method according to claim 16, wherein
the coupling surface of the first member includes a first protruding portion, and
the coupling surface of the second member includes a second protruding portion that extends in a direction different from a direction in which the first protruding portion extends when the first member is coupled with the second member.

18. The method according to claim 16, wherein
the coupling surface of the first member includes a first protruding or recessed portion, and
the coupling surface of the second member includes a second protruding or recessed portion that extends in a direction parallel to a direction in which the first protruding or recessed portion extends when the first member is coupled with the second member.

19. The method according to claim 18, wherein
the first and second protruding or recessed portions are arranged in a direction, such that an optical axis of the optical unit has an acute angle with respect to a surface of the bottom portion of the second member.

20. The method according to claim 16, further comprising:
forming a third member having an opening in which an optical fiber fits; and
attaching the third member in the first member, such that a direction in which the opening extends is the same as an optical axis of the optical unit.
